(19) United States
(12) Patent Application Publication
(10) Pub. No.: US 2011/0004827 A1
(43) Pub. Date: Jan. 6, 2011

(54) Scalable, Cross-Platform Method for Multi-Tile Display Systems

(75) Inventors: Kai-Uwe Doerr, La Jolla, CA (US); Falko Kuester, San Diego, CA (US)

Correspondence Address: PROCOPIO, CORY, HARGREAVES & SAVITCH LLP, 525 B STREET, SUITE 2200, SAN DIEGO, CA, 92101, US

(73) Assignee: THE REGENTS OF THE UNIVERSITY OF CALIFORNIA, Oakland, CA (US)

(21) Appl. No.: 12/920,056

(22) PCT Filed: Feb. 27, 2009
(86) PCT No.: PCT/US2009/035528

§ 371 Date: Aug. 27, 2010

Related U.S. Application Data
(60) Provisional application No. 61/032,748, filed on Feb. 29, 2008.

(51) Int. Cl. G06F 3/01; G06F 15/16

(52) U.S. Cl. 715/735; 709/208

(57) ABSTRACT

A distributed visualization system including a cluster graphics library for large scale, cross platform display environment (CGLX) is described. The distributed visualization system includes multiple slave nodes and one or more master nodes in communication with the multiple slave nodes in a network. The distributed visualization system further includes a network layer adapted for transmitting and receiving configuration and synchronization information, a cluster layer adapted for synchronization and event distribution of graphics context and content, render node layer for managing and synchronizing multiple rendering contexts according to the render nodes and one or more user interfaces associated with the one or more control nodes. The one or more user interfaces adapted for configuring and synchronizing the distributed visualization system, wherein the configuring and synchronizing of the distributed visualization system includes one or more control nodes configuring and synchronizing the multiple slave nodes.

### RELATED APPLICATIONS

This application claims priority to U.S. Provisional Application No. 61/032,748, filed Feb. 29, 2008, which is incorporated herein by reference.

### FIELD OF THE INVENTION

This invention relates generally to systems and methods for visualization and management of content on multiple displays and more particularly to a cluster graphics method for large scale cross platform display environments for supporting the creation of visual analytics cyber infrastructure systems.

### BACKGROUND OF THE INVENTION

Information visualization and management require a highly interactive visual representation of data for human interpretation. The tremendous amount of data produced in a wide range of scientific disciplines such as bioinformatics, geographic information systems, meteorology and earth science presents unique visual analytics challenges. To cope with data of this complexity and detail, and to aid in its analysis, a new generation of visual analytics infrastructure is required to enable researchers from different disciplines to collaboratively view, interrogate, correlate and manipulate data at resolutions commensurate with today's computational grids or dense sensor networks. A new generation of scalable, high resolution tiled display systems, operating at tens to hundreds of megapixels promise support for rapid visual analytics, i.e., analytical reasoning by means of interactive visualization. However, existing systems tend to be difficult to configure and control, which greatly limits their true potential. For instance, running a graphics Library or a graphics API, such as OpenGL (Open Graphics Library) programs developed for a single workstation on a cluster system with adequate performance characteristics often requires complicated time-consuming system configuration and reprogramming on the part of the user. At the same time, intuitive application programming interfaces for these visualization systems are not available.

With the emergence of highly interactive, scalable, multi-tile visualization systems such as the OptlPortals for global collaboration and research environments, as described by DeFanti [DeFanti et al. 2008], current approaches to managing networked visualization grids are only partially usable. Especially when multimedia content needs to be combined with interactive, real-time 3D computer graphics, the need for a high-performance, direct (hardware-accelerated) API to program visualization clusters becomes apparent.

Current solutions to utilize multi-display visualization systems are designed around the idea that these systems are used at local visualization facilities by a single operator, running mostly isolated simulations. The availability of high bandwidth network connections such as OptiPuter [Smarr et al 2003] and the increasing performance of commodity visualization components shift this paradigm towards highly interactive and collaborative workspaces exposing the shortcomings of current solutions. Essential requirements to support and develop applications for such systems require built-in characteristics such as:
Scalability and interactive performance;
Platform and hardware independent design;
Support for heterogeneous systems;
Handling of multimedia components in modules;
Easy-to-use programming interface;
System awareness of multiple collaborative work sessions and;
Multi-user event management on local and global networks;

Current techniques for visualizing OpenGL content on multiple displays require either the usage of a proxy-based DMX (Distributed Multihead X Project) server or utilizing Chromium [Humphreys et al. 2002], which is available for download on the World Wide Web from SourceForge. DMX operates on the assumption that a single front-end X server will act as a proxy to a set of back-end X servers. Rendering requests will be accepted by the front-end server, broken down as needed and sent to the appropriate back-end server(s) via X11 library calls for actual rendering. This architecture requires that the front-end server manages/renders the visual content of all nodes in a visualization grid. DMX is therefore limited to a small display array and not scalable without dramatic performance penalties. DMX is also not able to take advantage of the hardware acceleration on the rendering nodes which makes this solution impractical for a high performance rendering system.

Unlike DMX, Chromium is able to take advantage of the hardware acceleration on the tile nodes, but it comes with another limitation. Chromium uses tile sorting processes to determine which node in the cluster needs to draw which sections of the OpenGL content. Such a sorting process can produce bottlenecks when complex data structures need to be evaluated. Chromium splits the OpenGL commands and sends them in the form of a network stream to the corresponding nodes in the cluster. Stream Processing Units (SPUs) on these nodes will read the received “OpenGL Streams” and pass them directly to the local graphics card on the nodes. The user can configure Chromium in various ways using first-sort or last-sort behavior that allows all nodes in the visualization cluster to draw on one single image on a dedicated output server node or render their separate sections on the nodes locally. However, the involved components in these configurations such as pixel read-back, send and especially sorting SPUs require enormous CPU, GPU, bus bandwidth and network resources. Depending on the application this can decrease performance dramatically when the user attempts to visualize data on a large scale high resolution tile display system. Commercial software packages such as CAVElib, AmiraVR or ParaView require programmers to change their original OpenGL code substantially or assume that raw data sets are provided in a specific format and thus can be visualized with the available implementations.

Another approach to render visual content on a high resolution display wall was introduced by SAGE (Scalable Adaptive Graphics Environment) [Jeong et al. 2006]. SAGE operates on the assumption that any type of application will send a pixel stream to the SAGE server, which in turn manages the tiles and distributes the incoming pixels to the correct portion of a tiled wall. This concept has the advantage that any application can be displayed on tiled display systems as long as application programmers can derive a pixel-stream from their application (and enough network bandwidth is available). SAGE takes exclusive control of the distributed framebuffer. Thus, to display a high-resolution visual, another application needs to be running on the same cluster, rendering its content in an off-screen buffer which then can be read back and mapped to a SAGE client. Since read-back operations are expensive, the achievable performance of this approach is limited. The use of another visualization cluster to generate the high-resolution context is not an alternative because of the massive amount of data that would need to be controlled and streamed.

Middleware approaches such as Chromium and SAGE rely heavily on available network bandwidth with low latency, with the advantage that the display nodes do not necessarily need to have elaborate graphics capabilities. The down side is that, although current network solutions can theoretically provide throughputs of 10 Gbits/s and beyond, these maximum values usually can only be maintained when dedicated high performance local networks or high speed networks such as OptiPuter [Smarr et al. 2003] are combined with costly interconnection technology such Myrinet (Myri-10G), Scalable Coherent Interface (SCI) or Infiniband. Unfortunately, when budgeting a cluster, the wide price difference between high-performance and commodity interconnects favors in most cases a commodity interconnect with performance at or below a gigabit [Yeo et al. 2006]. This reduces the achievable performance with both Chromium and SAGE dramatically.

Accordingly, the need remains for a cluster graphics library for large scale cross platform display environments.

### SUMMARY OF THE INVENTION

The present invention provides a cluster graphics method for large scale, cross platform display environment, referred to herein as “CGLX”. The inventive method supports the creation of a powerful visual analytics cyber infrastructure system for knowledge discovery and innovation.

According to the present invention, a method is provided to create a unified virtual display environment using heterogeneous systems connected through a network. The method allows nodes connected to an arbitrary number of displays (tiles) to be networked, configured and synchronized to create scalable and spontaneously formable digital environments for information display, collaborative data correlation, fusion, analysis and dissemination. Individual nodes pose knowledge about their own capabilities and can communicate this information or be remotely accessed and queried. However, individual nodes (primarily render and display nodes) can remain unaware of other resources in the network. Selected control nodes (head nodes) can query the network and obtain an inventory of available resources/assets and composite these into extended, multi-tile display contexts. The multi-tile context may exist in a co-located format, multiple-physically adjacent tiles ad collections of spatially separated networked tiles, thereby allowing visual information to be seamlessly shared, and explored at resolutions commensurate with the problem domain at hand. Through a visual interface the environment is freely configurable and can be partitioned, merged or otherwise reshaped.

The inventive method is cross-platform, operating system independent, supports heterogeneous configurations, and is self configuring. This can be distinguished from middleware approaches such as Chromium and SAGE, which rely heavily on quality of service assumptions such as the availability of low latency, high bandwidth networks, single point control over the environment, fixed resource allocation and operating system. One of the advantages of existing approaches is that the display nodes do not necessarily need to have elaborate graphics capabilities, allowing node cost to be reduced. The downside is that although current network solutions can theoretically provide throughputs of 10 Gbits/s and beyond, these speeds can usually only be maintained when dedicated high performance local networks or a high speed network grids such as OptiPuter are combined with costly interconnection technology such Myrinet (Myri-10G), Scalable Coherent Interface (SCI) or Infiniband. Unfortunately, the significant price difference between high-performance and commodity interconnects favors a commodity interconnect with reasonable performance, such as a Gigabit Ethernet when budgeting a cluster. This can dramatically reduce the achievable performance with both of the middleware approaches discussed above. CGLX explores a different approach, assuming that the rendering nodes in a cluster have sufficient CPU and GPU resources available. This is a viable assumption considering that most workstation vendors push multi-core processor systems to maximize computational performance. Graphics card vendors follow the same strategy by adding more parallel pipelines to their graphics cards (GPUs).

CGLX is useful as a complimentary framework that can leverage all available resources by utilizing classical work distribution strategies in cluster systems such as culling and multi-threading. To maximize the availability of network resources for data transmission related to the visualization content, CGLX implements its own lightweight network-layer, allowing it to control and synchronize the visualization grid and propagate user interactions to all nodes in the system. The CGLX framework eliminates cumbersome script configuration and shell programming, through auto-discovery of system assets and providing users of any skill level with full control of the display environment and content distribution. CGLX provides full access to hardware accelerated rendering across different operating systems and maximizes pixel output to support ultra-high resolution tiled display systems. The framework was designed to create scalable, high-performance tiled-display systems that maximize both pixel control and rendering performance by leveraging local and remote assets.

The inventive method provides unified user event management for inhomogeneous, networked systems and allows event handling for multiple synchronized graphics contexts per display node. Additional advantages of the inventive system include minimal network utilization for environment control purposes, ease of use through GUI based grid configuration, straight translation of single-node graphics applications to scalable cluster-aware applications, and rapid deployment.

### BRIEF DESCRIPTION OF THE DRAWINGS

FIG. 1 is a diagram of one embodiment of the middle architecture of the inventive system.

FIG. 2 is a diagram of one embodiment of the frame components of the inventive system.

FIG. 3 is a diagram of one embodiment of the configuration and visualization subsystem.

FIG. 4 is an illustration of one embodiment of a simulated screen shot showing the configuration tool esconfig with ServerConnection module.

FIG. 5 is an illustration of one embodiment of a simulated screen shot showing the server configuration module ServerConfig.

FIG. 6 is a diagram of one embodiment of a simulated multilayer event and display distribution.

FIG. 7 is a diagram of one embodiment of the internal program stages in threaded mode.

FIG. 8 is a diagram of one embodiment showing the event transport mechanism on inhomogeneous visualization grids.

FIG. 9 is a diagram of one embodiment showing event handling for multiple Open GL contexts on a local node.

FIG. 10 is a listing of one embodiment of a sample code for switching from GLUT to CGLX.

FIG. 11 is a diagram of one embodiment of a configuration for a tiled test system.

FIG. 12 is a diagram of one embodiment of a graph with overlayed images showing scalability of CGLX in serial mode.

FIG. 13 is an illustration of one embodiment of graph comparing 15 nodes with synchronized threaded mode, pixelratio.

### DETAILED DESCRIPTION OF THE EXEMPLARY EMBODIMENTS

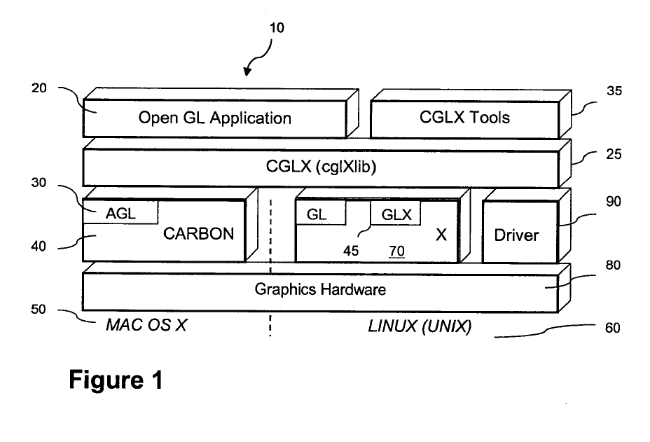

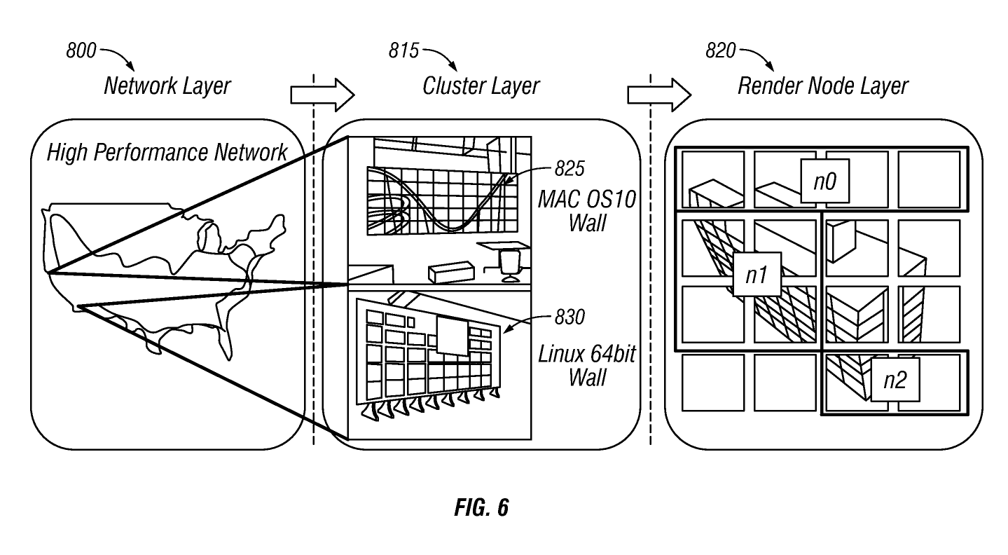

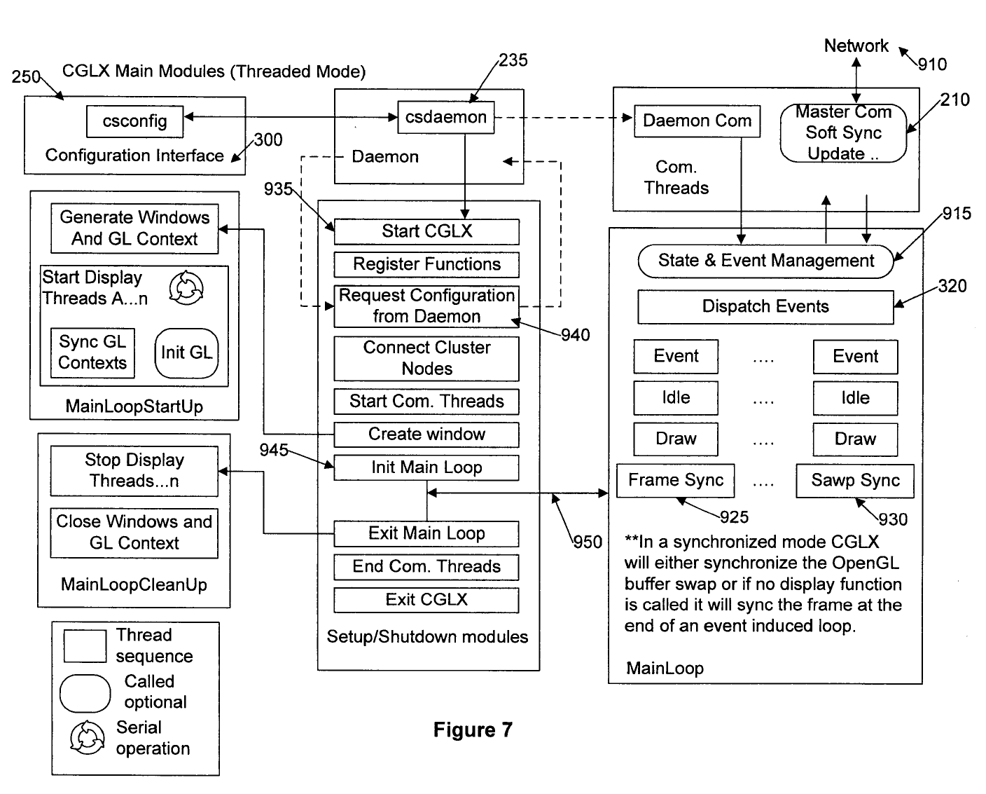

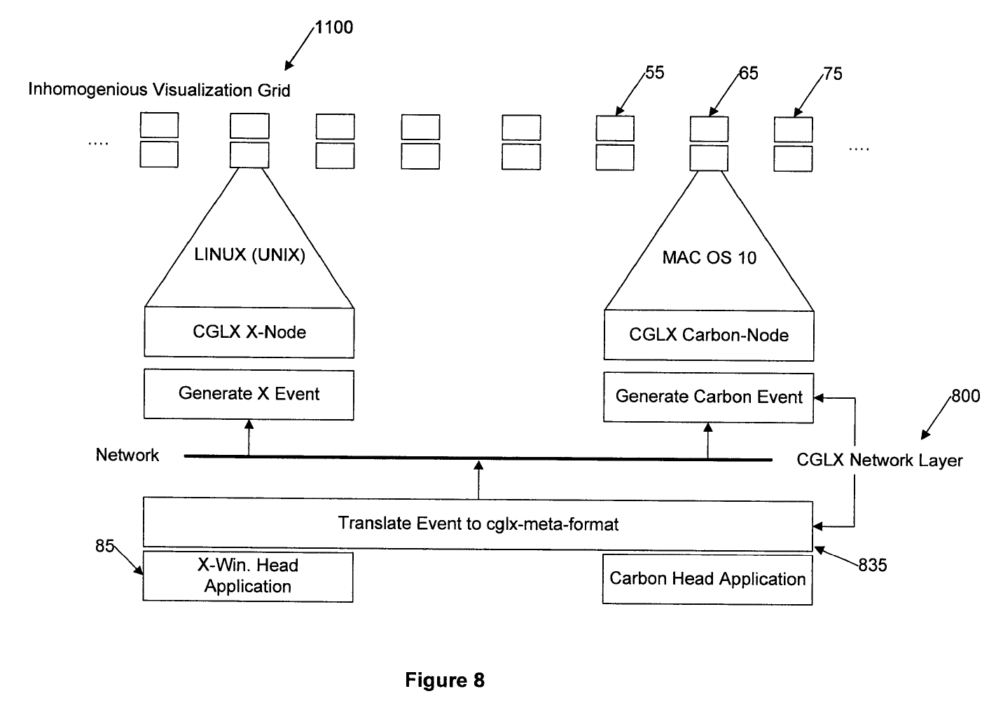

According to the present invention, CGLX manages multiple display configurations across three distinct layers including the network layer 800, the cluster layer 815 and the render node layer 820, as shown in FIG. 6. The network layer 800 allows users to configure distributed tiled display systems and start applications across the network. On the cluster layer 815 the method and/or system handles event distribution and synchronization of the graphics context and content as well as frame and event synchronization. The synchronization of buffer swaps is implemented as software solution and is exchangeable with the implemented support for hardware frame/swap synchronization if this feature is also supported by the graphics cards 80 (see FIG. 1) in the visualization grid 1100 (see FIG. 8). The visualization grid 1100 includes one or more master nodes 85 (control nodes) and multiple slave nodes 55, 65 and/or 75 (render nodes, display nodes, see FIG. 8)). On current graphics cards the OpenGL context buffer size is limited to the GPU capacity (typically to 4096 by 4096 pixels), which prevents OpenGL context sizes to grow further. While the system and method is described using OpenGL or GLUT as an example, the system and method is compatible with other Graphics Library and Graphics API's. To avoid this limitation CGLX manages and synchronizes multiple rendering contexts in its render node layer 820 (see FIG. 6). This feature allows CGLX to render and synchronize OpenGL applications 20 (see FIG. 1) in multi-display-full-screen mode on render nodes with multi-high-resolution display setups. The number of manageable high resolution displays (e.g., 2560×1600) is hereby not limited by the framework. The capability of the desktop manager provided by the operating system and the available hardware resources define the expectable performance of the system. CGLX allows users to explore the capabilities of their system and let them choose to configure and manage their system according to their specific needs. The system architecture is shown in FIG. 7.

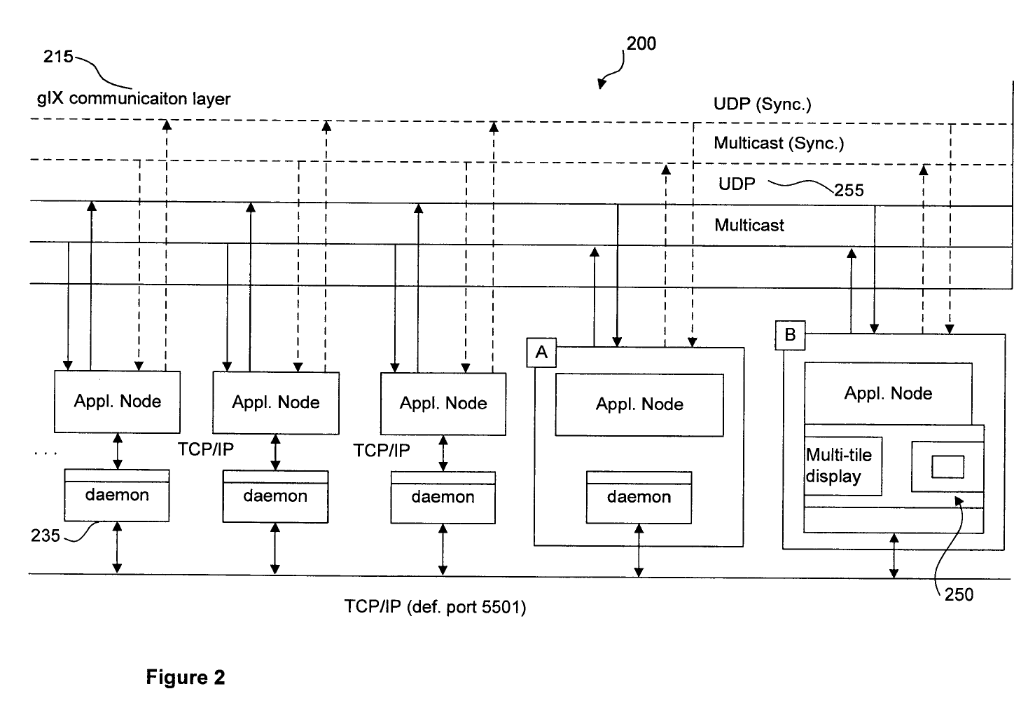

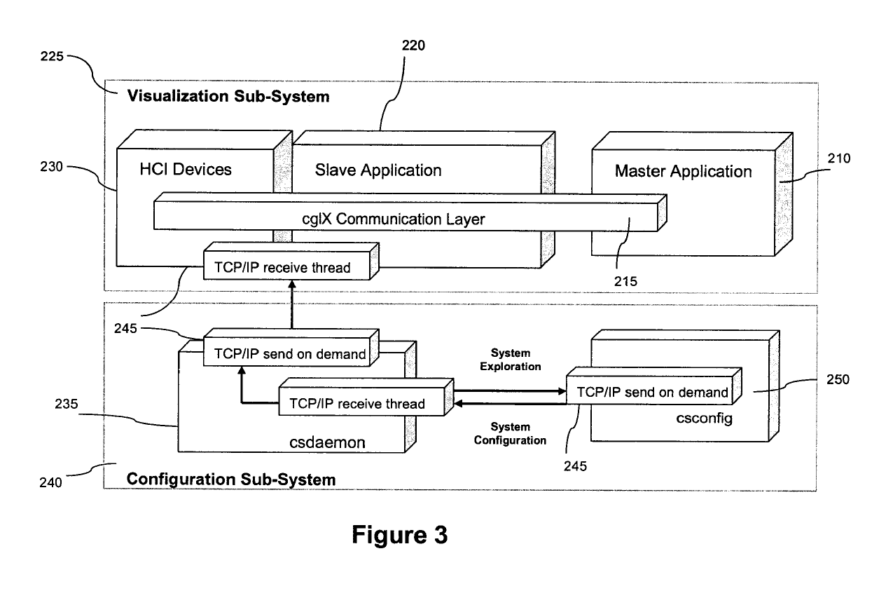

CGLX (Cluster Graphic Library For Large Scale Cross Platform Display Environments) is a flexible transparent OpenGL-based graphics framework for distributed high performance visualization systems in a master-slave setup. The framework was developed to enable OpenGL programs to be executed on visualization clusters such as a high resolution tiled display system and to maximize the achievable performance and resolution for Open GL based applications on such systems. To overcome performance and configuration related challenges in networked display environments, CGLX launches and manages instances of an application on all rendering nodes 55, 65 or 75 through a light-weight thread-based network communication layer 215 (see FIG. 3). A GLUT-like (Open GL Utility Toolkit) interface is presented to the user, which allows this framework to intercept and interpret OpenGL calls and to provide a distributed large scale OpenGL context on a tiled display 825 and 830 (see FIG. 6). CGLX provides distributed parallized rendering of OpenGL applications 20 with all OpenGL extensions that are supported through the graphics hardware 80. One of the unique qualities of the CGLX framework 200 (see FIG. 2) is that OpenGL programs will run with minimum or no changes to the original code. Similarly, CGLX requires no additional proprietary file formats or APIs other than those already provided in OpenGL. Each render node 55, 65 or 75 utilizes the local hardware acceleration to its full potential. The framework provides a graphical user interface (GUI) and tools to easily test, setup, and configure a cluster visualization system or distributed visualization system.

CGLX explores an approach, assuming that the rendering nodes 55, 65 or 75 in a cluster have sufficient CPU and GPU resources to their disposal. This is a viable assumption considering the fact that today's workstation developers push multi-core processor systems to maximize computational performance while graphics card manufacturer follow the same strategy by adding more parallel pipelines to their graphics cards. CGLX is particularly useful as a complimentary framework that can leverage from these resources by utilizing classical work distribution strategies in cluster systems such as culling and multi-threading. To maximize the availability of network resources for data transmission related to the visualization content, CGLX implements its own lightweight network layer 800. This layer enables the framework to control and synchronize the visualization grid and propagate user interactions to all nodes 44, 65 or 75 in the system.

The inventive framework eliminates cumbersome script configuration and shell programming, which also enables non-experienced users to utilize a tiled visualization system with full control over the displayed content. CGLX provides users with access to hardware accelerated rendering on different operating systems and aims to maximize pixel output to support high resolution tiles display systems. The framework was designed to improve usability and performance of tiled-display systems with the emphasis on:
1. Providing an easy-to-use GUI-based grid configuration;
2. Minimizing or eliminating changes to existing OpenGL applications 20;
3. Minimizing network usage for control purposes;
4. Maximizing rendering performance by utilizing local hardware acceleration; and
5. Maximizing the pixel output on high resolution tile-display systems.

### CGLX Architecture

In general, CGLX allows OpenGL applications 20 to be displayed on visualization clusters like a tiled display 830 or a multi-projector system. The availability of a cluster environment is hereby not mandatory. As far as CGLX is concerned, a cluster consists of several workstations that are interconnected with a fast network according to the definition by Buyya [Buyya 1999] and Pfister [Pfister 1998]. However, standard key components of a cluster such as a parallel programming environment or a Single System Image (SSI) and availability of the infrastructure often described as cluster middleware are not required to run CGLX. Although a cluster management system such as for example ROCKS [Papadopoulos et al. 2001] is not required, it usually provides a convenient setup of services such as NFS (Network File System), user management and the necessary network configuration out of the box.

A visualization system managed by CGLX is not bound to a cluster setup and does not require special network equipment. To emphasize this fact, the networked components in a tiled system (rendering nodes) is referred to as a “visualization grid”. FIG. 1 shows the general software architecture 10 of the CGLX framework 200 (see FIG. 2). Currently CGLX supports X-windows systems 70 on UNIX platforms 60 and Apple® Mac® OS X 50 natively. The availability of CGLX can also be extended to the Microsoft Windows® operating systems.

The middleware layer is implemented as a shared library cglXlib 25 which is required for all CGLX tools 35 and user applications. The core function of this library 25 is to provide the grid as well as the simulation management system that runs in the background as soon as an application is started. The library 25 also provides application programmers with a very simple interface to the CGLX framework 200, with access to the network resources and other currently implemented human computer interaction (HCI) devices 230 such as space mouse and joystick.

On X-based operating systems 70, CGLX utilizes GLX 45 to achieve direct rendering. On Mac OS X systems 50 the GLX framework 200 wraps the native AGL 30 and Carbon framework 40 so that the presented API has a common appearance on all operating systems and code changes are not required when moving from one operating system to another. The library 25 can also take advantage of features implemented in graphics card drivers 90 to explore if graphics capabilities such as swap and frame synchronization are available on the rendering nodes 55, 65 or 75 and to determine local hardware setups such as the number of connected monitors and their arrangement. If these features are not available through the driver 90, CGLX queries the X-server 70 or Carbon 40 to determine this information.

The configuration of distributed systems often requires in-depth knowledge about the system topology and experience in scripting and editing of configuration files, which can be daunting for novice users. Moreover, if users lack a clear understanding of the cluster middleware's underlying principle, software design errors are inevitable. This leads to applications that are not capable of utilizing resources as intended by the framework along with poor performance characteristics and maintainability. Therefore, an additional objective in the development of CGLX was to provide a simple, transparent, and structured framework with a clear separation of tasks for each component.

FIG. 2 shows the general structure of the CGLX framework 200 and the interconnection between the basic components. Overall the CGLX framework 200 can be described as a combination of a configuration subsystem 240 and a visualization subsystem 225 as shown in FIG. 3 with a tight communication between both components. The configuration subsystem 240 communicates with the visualization subsystem 225 through an independent tread-based TCP/IP 245 connection. This non-blocking communication channel between the configuration and visualization subsystems 240 and 225 allows to dynamically change the configuration and status of the visualization grid during application runtime. The CGLX framework 200 is based on a master-slave approach where the master application 210 (see FIG. 3) running on the head node serves as control instance and interface to the slave application 220 running on the grid (see FIG. 3). The interface between the master application 210 and the slave application 220 is the CGLX communication layer 215. A separate instance of an OpenGL program 20 will be started on each node on the grid 1100. The communication between the head and slave application is managed by the communication layer 215 implemented in CGLX framework 200. To configure nodes 55, 65 or 75 in a grid 1100 a daemon program (csdaemon) 215 must be started as a background process during the startup of the rendering nodes or via remote command at any given time. Many cluster systems also provide a mechanism to start an application on all nodes with a simple call (e.g., a cluster-fork in case of a ROCKS distribution), which can be utilized to start the daemons 235.

The graphical configuration tool esconfig 250 connects to these daemons 235, allowing remote access to the each node in the grid from any workstation or PC in the network (see FIG. 7). The daemons 235 are used to configure the remote visualization system and to start user application and device services provided by CGLX. Both tools will be described in more detail in the following chapters.

### Configuration Interface

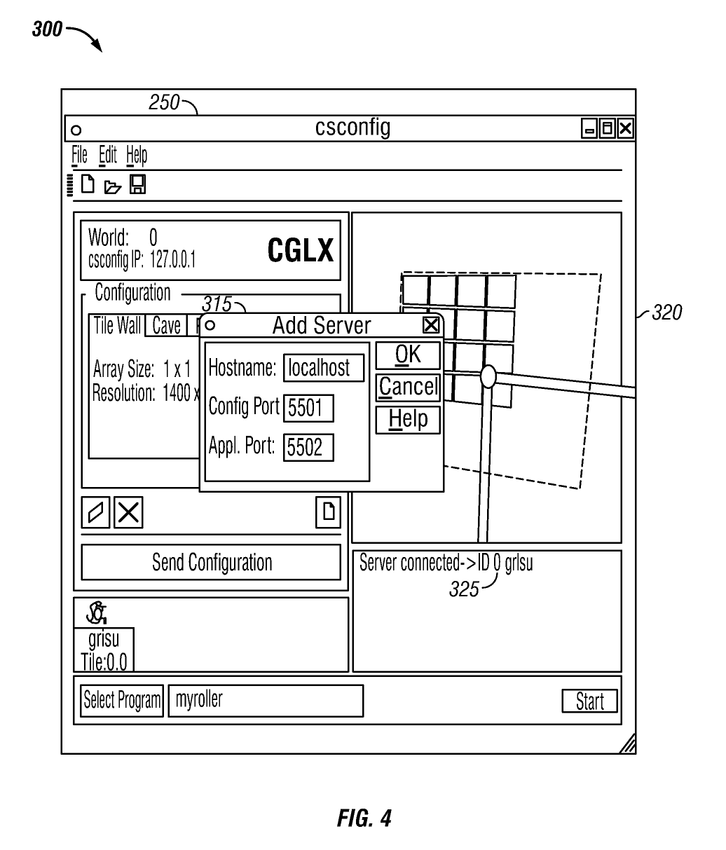

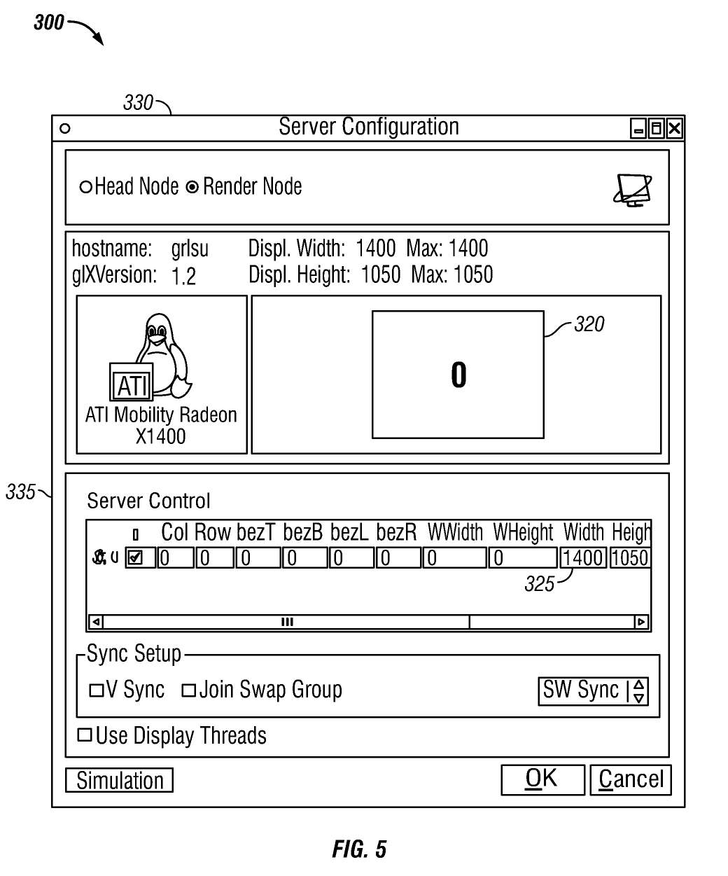

FIGS. 4 and 5 illustrate different modules of the configuration interface 300. In particular, FIG. 4 is showing the main interface of the configuration tool esconfig 250 with the ServerConnection module 315. To avoid problems with the configuration, a more user-friendly approach is taken based on a graphical user interface. The configuration interface 335 enables users to dynamically configure and utilize a tiled visualization system build from available commodity workstations and PCs. All information needed to configure the system is presented in a transparent graphical form. The interface 335 features a graphical representation 320 of the current configuration as well as a text-based assistant 325 for all setup features and information presented in all configuration modules. The configuration tool 250 can be started on any networked workstation, PC or even a tablet PC. The basic configuration of a tiled display system includes the following three simple steps.

1. Connect to a server/rendering node via csdaemon 235;

2. Configure the server according to multiple parameters illustrated in FIGS. 4 and 5, for example; and

3. Select and start an application.

In the first step, the server needs to be added to a configuration, by entering either IP address or the unique domain address into the Server Connection module 315 (FIG. 4 center dialog). As soon as the servers (daemons) reply, each node can be configured with the server module ServerConfig 330 shown in FIG. 5.

While connecting to the selected server the configuration tool 250 also requests information about the servers such as available hardware and installed OpenGL version. The information is displayed to the user so that he can decide which features of the remote system should be used. Other modules allow for configuration of external devices such as a spacemouse or joysticks. The configuration can be stored and loaded for any other application.

### Server Configuration Module

FIG. 5 illustrates a simulated screen shot showing the server configuration module ServerConfig 330. The ServerConfig module 330 allows configuring of each server independently. FIG. 5 is illustrated in conjunction with the event transport mechanism on inhomogeneous grids illustrated in FIG. 8. Users can decide which node 55, 65, 75 and/or 85 on the network/visualization grid 1100 will start the head/master application 210 and which nodes will run the slave application 220 to form the tiled display 830. This module 330 shows all displays available on a server in an editable table as well as their current resolution. To configure the outline of the tiled display 830 (see FIG. 6), users can specify monitor dimensions and bezel sizes (if needed). The number of monitors that can be connected to each server 55, 65 or 75 (see FIG. 8) is only limited by X 70 on Unix systems 60 and Carbon 40 on MAC OS X 50.

To synchronize the buffer swaps in the grid 1100 two mechanisms are implemented in CGLX. The software synchronization is the default synchronization mechanism, however some graphics cards feature frame-sync and swap-sync with so-called G-Sync cards that can be selected instead if available. The interface allows to run a synchronized or a non-synchronized visualization grid 1100 and offers users to choose if and which synchronization mechanism should be used depending on available hardware support and application requirements.

Depending on the number of CPUs available and the number of displays connected, users may choose from two different operation modes. If multiple CPUs are available on a server, a CGLX application can be locked to a single CPU. In this mode, called serial mode, other CPUs can be used for simultaneous, computational intense processes without effecting the performance of the visualization. In the threaded mode CGLX runs a separate thread for each window/display that is configured on a server node. This approach enables CGLX to leverage from all CPU and GPU resources on the node and to maximizes the visualization performance. Both modes can be combined and used arbitrarily on the grid 1100. A more detailed description of available modes in combination with different display setups will be described below.

### Server Controlled Mode

In the server controlled mode the configuration sub-system the system tries to setup the visualization grid 1100 semi-automatically with the information requested from the server 55, 65, or 75. The only user information that is needed in this mode, is the IP address of the rendering servers 55, 65, or 75 and the position (column and row) of connected monitor/display in the visualization grid.

### Simulation Mode

The CGLX framework allows to test and program an application for a visualization grid on a single workstation through its simulation environment. A simulation environment can be set up on a single workstation or node 85 (see FIG. 8). The configuration subsystem 240 allows to configure the CGLX framework for simulation mode which enables users to test their application with a simulated grid on a single node 85. For example, an interactive simulation of a 4×4 tiled display can be viewed on the monitor of a single workstation, allowing the user to visualize how the application will perform and appear when rendered on a tiled display system (the setup preview window 320 in FIG. 4 shows such a scenario). The simulation mode operates based on the same underlying principles and mechanisms as an application running on a visualization grid 1100 of FIG. 8.

Other than the standard CGLX configuration mode (server controlled mode), the simulation mode lets users configure each parameter manually. The flexibility of this mode can also be used to configure nodes 55, 65 or 75 in the visualization grid 1100, allowing arbitrary window dimensions and positions as well as the combination of multiple sub-displays on each node 55, 65 or 75. This feature is most valuable for applications where the user intends to display different graphical content in reference to the same underlying model and viewpoint or for applications where a side-by-side comparison of datasets is desired. For example, a set of computer tomography (CT) or magnetic resonance imaging (MRI) slices can be displayed side-by-side to facilitate comparison. Other applications that would benefit from side-by-side comparisons include time series images of geologic and oceanographic conditions, and climate or weather changes.

### Control Daemons

The daemons 235 are part of the configuration subsystem 240 as shown in FIG. 3 and serve as control instances to access nodes 55, 65 and 75, for example, in the grid 1100. The daemons 235 must be started prior to the configuration of the visualization system 225 to allow the CGLX framework 200 (see FIG. 2) to take control over the nodes in the grid 1100.

A CGLX daemon 235 is a lightweight process running in the background that will start applications with a system command as provided through the configuration tool. Immediately after the application 220 or a device server on the nodes 55, 65 or 75 has been started it opens a communication channel back to the daemon 235 and requests the configuration. This communication via TCP/IP 245 between application 220, daemon 235 and the configuration tool 250 will stay active by default as long as the application 220. The connection between configuration tool 250 and daemons 235 however, can be terminated and re-established at any time. This feature allows for dynamic changes to the configuration of each rendering nodes 55, 65, or 75 during runtime and for access to the visualization sub-system 225 from outside of the application through the configuration tool esconfig 250.

### CGLX Library

The goal of CGLX is to provide a transparent and easy-to-use performance optimized middleware that allows OpenGL desktop applications to run on a tiled display 830 with minimal or no changes to the original code. The visualization subsystem 225 is controlled and managed through the dynamic shared library called cglXlib 25. Library 25 resembles the core engine of the framework 200.

The key features of library 25 are:
1. Cross platform OS independent interface;
2. Optimized management of local hardware resource through event-based approach;
3. Multi-layer event and display distribution;
4. Support for multiple displays per rendering node;
5. Multi-thread support;
6. Synchronized context swaps and distributed event handling; and
7. Access to hardware accelerated rendering via multilevel API.
8. Multi-user event management on local and global networks

### Multi-Layer Event and Display Distribution

FIG. 6 is a diagram of a simulated multilayer event and display distribution. CGLX was designed to manage multiple displays setups on three layers, the network layer 800, the cluster layer 815 and the render node layer 820 as shown in FIG. 6. On the network layer 800 such a setup provides users with an option to configure distributed tiled display systems and start applications 220 and/or 210 across high speed networks 910. The event distribution in the network layer 800 is currently based on a master-slave approach in which only one participating wall is capable of producing events for the distributed system. On the cluster layer 815 the middleware handles event distribution and synchronization of OpenGL buffer swaps as well as frame and event synchronization. The synchronization of buffer swaps is implemented as software solution according to the swap synchronization module 330 and is exchangeable with the implemented support for hardware frame/swap synchronization if this feature is also supported by the graphics hardware 80, for example graphics cards, in the visualization grid 1100. On current graphics cards the OpenGL context buffer size is limited to the GPU capacity (typically to 4096×4096 pixels), which prevents OpenGL context sizes to expand further. To avoid this limitation, CGLX manages and synchronizes multiple rendering contexts in the render node layer 820. This feature enables CGLX to render and synchronize OpenGL applications 20 in multi-display-full-screen mode on render nodes 55, 65 or 75 with multiple high-resolution display setups. The number of manageable high-resolution displays (e.g. 2560×1600) is hereby not limited by the framework 200. The capability of the desktop manager provided by the operating system and the available hardware resources define the achievable performance of the system. CGLX allows users to explore the capabilities of their system and lets them choose to configure and manage their system according to their specific needs.

### Internal Structure

Depending on the hardware configuration available on a system, users can select to run a CGLX application either in a serial mode or, if multiple CPUs are available, in a multi-threaded mode. FIG. 7 is a diagram of the internal program stages in threaded mode. The framework 200 lets users register callbacks for example for rendering, event handling and various forms of inter-node communication (message passing). To avoid a bottleneck arising when the head or master application 210 has to render the same amount of data as the rendering nodes 55, 65 and 75 in the grid, users can choose to exclude the head or master application 210 from executing the display callback. In this case the head application 210 manages only synchronization and event distribution. FIG. 7 shows the processes and stages involved in the background when a cglx application is started in the threaded mode. The head application 210 handles event distribution and synchronization of OpenGL buffer swaps as well as frame and event synchronization. The event distribution and synchronization is implemented in a state and event management module 915 that may include a dispatch events module 920, a frame synchronization 925 module and a swap synchronization module 930.

To start a CGLX application users select a program with the program manager (see bottom of configuration tool FIG. 4) built into the configuration tool 250 or a command line scriptable interface. During startup of a program the connected daemons 235 will start instances of the application in parallel on the visualization grid 1100. The daemons 235 are able to start head instances (master) and render node instances (slaves) on any workstation or node 55, 65, 75 or 85 on the network 910. This feature allows users to decide on which workstation or node 55, 65, 75 or 85, for example, they want to interact with the application on the visualization grid 1100. The slave instances 220 in the grid 1100 request their configuration during their own startup routine from the daemons in the CGLX program startup module 940, configure themselves accordingly, and pass this information later on to the master instance (head application) 210. The framework library 25 will determine how many nodes 55, 65, or 75 in the visualization grid 1100 are available and establish the needed communication between the master 210 and slave instances 220 of the application. When this communication is established the master application will establish and launch the needed services for the gid. In the startup stage a CGLX program (master and slave entity) registers user-defined callbacks to the system. All registered callbacks can be unregistered at any time in the program. All OpenGL states set by the user before the main loop is started, according to the init main loop module 945, will be applied to a shared context provided by CGLX during the startup sequence.

The initialization of rendering contexts can be controlled with the registration of an initialization callback. If multiple OpenGL contexts/windows are configured and users do not define a callback function for the context initialization, CGLX will apply/copy all detectable OpenGL states defined in the shared context to all other OpenGL windows in a synchronization step. After these initialization stages the program enters the CGLX main loop, as illustrated by the arrow 950, in which the state and event management system 915 dispatches events to the rendering contexts and synchronizes them on a per node base as well as on the visualization grid 1100. The event handling and synchronization of rendering contexts in the CGLX main loop is described in more detail below. Unlike a GLUT-based application, CGLX applications will return from the main loop, which enables users to execute program code before the application terminates.

The interception mechanism of OpenGL calls in the CGLX framework is only used to provide a distributed rendering context between multiple rendering nodes. Code for the OpenGL pipeline and functionality is uchanged which allows the utilization of shader code such as GLSL (OpenGL Shading Language) and parallel GPU programing interfaces such as the CUDA (Compute Unified Device Architecture) interface and support for all extensions available through the graphics driver 90 and hardware, installed on the systems. To provide an illustrative example, an interactive shader-based CGLX application can be generated on a 286 megapixel display wall featuring 70×30-inch displays with a resolution of 2560×1600 pixels per tile. An actual system that has been constructed, known as “HiPerSpace” (Highly Interactive Parallelized Display Space), is driven by 18 quad core Dell XPS 710 workstation with dual NVIDIA FX5600 Quadro graphics cards.

### Network and Synchronization

The visualization grid 1100 is controlled by several lightweight communication threads. The data exchanged between head 85 and rendering nodes 55, 65 and 75 is reduced to packages for events and synchronization purposes. To avoid package-wait states and to separate user-induced event transmission from CGLX control messages, the framework 200 utilizes several multicast channels for communication between master and slave applications 210 and 220, synchronization and dedicated UDP channels 255 (Illustrated in FIG. 2) for reply messages from the nodes in the visualization grid 1100. The network layer 800 of the framework 200 detects lost packages during runtime and resends them until a node 55, 65 or 75, for example, is detected as inoperational. The design of the framework library 25 allows the combination of rendering nodes 55, 65 or 75 with different computer architecture (32 and 64 bit) and operating systems, such as Linux, Mac OS X and Windows. The system detects an inhomogeneous visualization grid 1100 and reacts accordingly by byte order correction if necessary.

All packages transmitted through the network layer 800 are converted to a cglx-meta-format in the event protocol layer of CGLX 835 illustrated in FIG. 8 which allows CGLX to manage unified send-and-receive packages on the network. Received packages are translated according to the operating systems requirements. FIG. 8 shows this feature being implemented in the network layer 800 which allows adaptive event creation and the combination of X-Windows based systems 70 with Carbon 40 managed desktops in one visualization grid 1100.

As mentioned earlier CGLX can be started in a synchronized and a non-synchronized mode depending on user's requirements. A non-synchronized startup is intended to serve applications that consider each display as a separate entity. Users can query the location of each display in the grid and show different content for side-by-side comparison of related datasets or applications that have to show independent graphical content (e.g., a video surveillance system with simultaneous feeds from different locations).

In configurations where the whole or parts of the visualization grid 1100 should be used to form a unified OpenGL context, a CGLX application has to be started in a synchronized mode. In this mode, CGLX will either synchronize the OpenGL buffer swap 930 or synchronize the frame 925 at the end of an event-induced loop if no display function is called. To realize synchronization on the visualization grid 1100 and on local workstation with multiple displays, CGLX uses network layer 800 controlled thread barriers to swap OpenGL buffers and to guarantee a step locked execution of the program as shown in FIG. 7.

### User Interaction and Event Handling

Users interact with their application through the master instance 210 started on a workstation in the network, usually called a head node 85. Events induced by user interaction with the application running on the head node 85 have to be propagated to the slave instances 220 in the visualization grid 1100. To support the combination of workstations with different operating systems (inhomogeneous visualization grid 1100), the network layer 800 in CGLX implements a cross-platform event transport mechanism based on a meta format for network packages as described in the previous chapter. An event created on a master instance 510 passes through the event protocol layer of CGLX 835 before it is sent through the network. The event packages received on the slave instances 220 pass again through this layer and are mapped to a local event structure before being raised on the system as shown in FIG. 8. This feature allows CGLX to raise events specific to the operating system installed on each workstation.

To save valuable computational resources, CGLX is designed based on an event-driven approach, that is similar to the implementations of GLUT (the event-driven approach signifies that CPU or GPU resources are utilized only when users interact with the system or the registered idle functions are executed). Although CGLX can behave like a GLUT implementation, the framework does not make any assumptions on when, for example, a window/context has to be redrawn. Also, the execution of idle callbacks is strictly regulated in CGLX and is only possible when no draw or user events reside in the event queue. This CGLX feature offers users an opportunity to keep full control of their application so that unnecessary or unwanted execution of registered callbacks (that can negatively affect the performance) can be avoided.

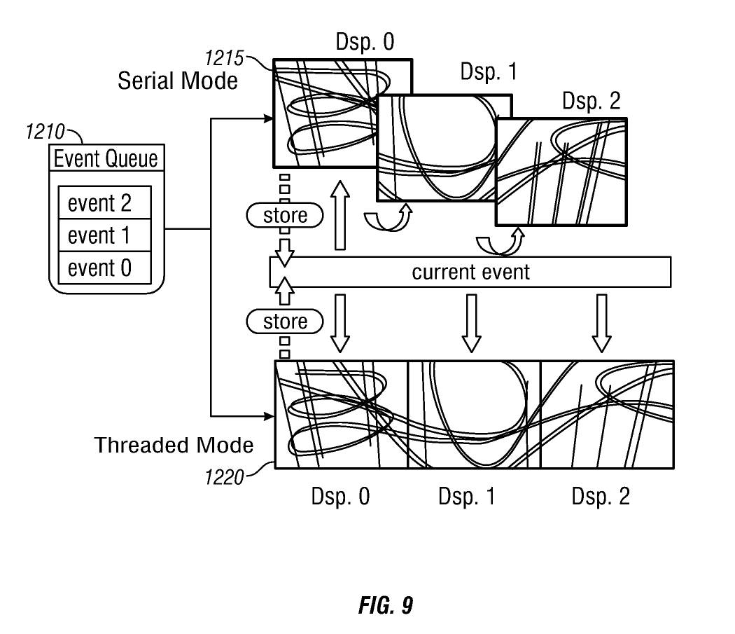

FIG. 9 is a diagram of event handling for multiple Open GL contexts on a local node. To optimize event handling for multiple windows CGLX implements a mechanism as shown in FIG. 9. Events from the head application are only sent to the client-event queue 1210 of the first window 1215 (for serial mode) and/or 1220 (for threaded mode) of an application running on a slave instance 220. This feature avoids sending events to all windows of the application, which is unnecessary because all windows will have to process the same event. This mechanism eliminates additional delays introduced by the transport mechanism between the server- and the client event queue 1210 on an X window based system 70. The event is stored in a local event structure dedicated to each window, which allows independent event execution in the serial and threaded mode on a per window basis.

Handling single and multi-user events in a highly parallel application is one of the most challenging tasks for distributed systems. The system/program has to cope with network related problems such as delays in package delivery, package losses and synchronization issues. CGLX hides the complexity of these problems behind the API, which allows users to focus on writing their application.

### World Concept

Another unique feature of CGLX is that users can also split a visualization grid 1100 such as a tiled-display wall 830 to run multiple programs side by side. To support this feature CGLX is designed with a built-in awareness of different simulation worlds called the World Concept. Each world uses hereby different network ports and communication channels allowing users to start a CGLX application in a dedicated environment that is unaware of other CGLX programs running on the same network. Users can select from ten different predefined worlds or define their own settings allowing maximum flexibility to utilize the simulation World Concept. To provide an illustrative example, an 11×5 tiled system can be split into three different simulation worlds, where the left side shows an HD video playback on a 4×5 tile configuration, the center section shows an interactive 3-D model on a 3×5 tile setup, and the right side runs an interactive high resolution image viewer in a 4×5 configuration. All applications can be controlled from the corresponding master instance running on the head node 85. To allow users to interact simultaneously with an application on the grid 1100, each master instance can be started on a separate head node 85. In addition to handling events induced at the head node application, the framework is designed to handle also event from multiple input devices such as other workstations as long as they are connected to the head node of each application. A head node 85 in this example can be a powerful workstation on the network or a wireless connected laptop, which serves as the user interface to an application running on the grid 1100. The simulation World Concept enables multiple users or groups to share the visualization grid 1100 for independent visualization purposes or cooperative data analysis.

### Programming Interface

The exposed API is designed to provide a dual layer interface: The basic CGLX interface emulates a well-known graphics programming interface (GLUT) for non-experienced users while the advanced interface allows additional program code optimizations for multi-display and multi-thread support. Similar to Chromium, CGLX has to intercept OpenGL calls to generate and manage the OpenGL context on the visualization system. However unlike Chromium, where all OpenGL calls have to be intercepted and therefore have to be re-implemented, CGLX only needs to intercept calls that manipulate the projection matrix. This approach permits CGLX users to utilize the newest OpenGL versions with all available extensions.

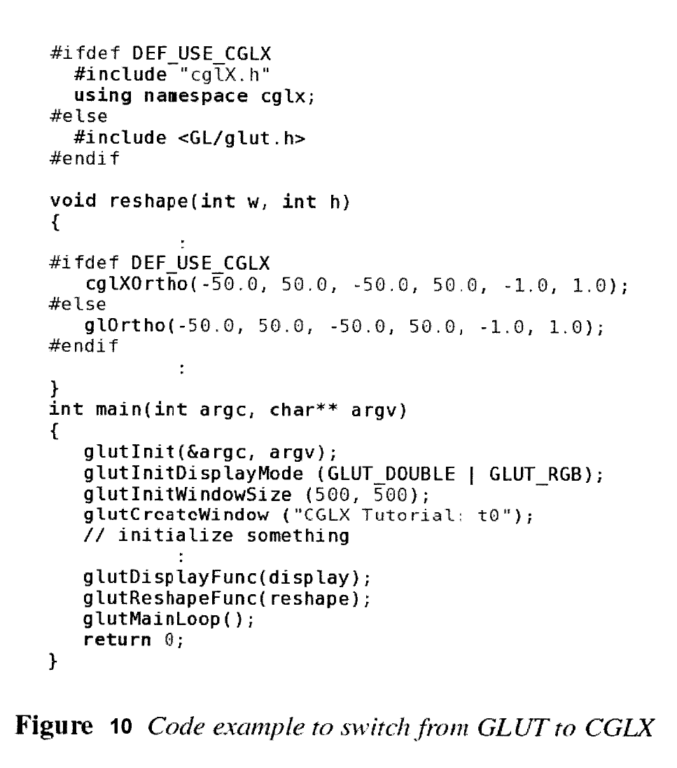

To run an OpenGL application 20 on a visualization grid 1100 the application needs to be compiled against the cglXlib 25. This requires minor code changes, such as including the cglx header and switching to the cglx namespace as shown in the code example in FIG. 10. To enable CGLX to intercept calls that control the OpenGL projection matrix such as glOrtho( ) the function has to be exchanged against cglXOrtho( ) keeping the same parameters. Internally CGLX will reinterpret these parameters and correct the projection matrix according to the tile setup of the grid. As the above pseudo code example demonstrates CGLX does not require users to change the “glut” prefix. CGLX has wrappers for most of the GLUT API calls in its namespace. Users who wish to program exclusively for CGLX can switch to the corresponding function names of the CGLX API start with cglX instead of glut. A CGLX program can be started as a stand alone application directly from a terminal. In this case the application does not require the configuration tool or any daemons.

Additional functionality is provided by the advanced API, allowing programs to query information about the visualization grid, the local tile setup and further optimizing their code for multi-display and multi-thread support.

### Message Passing

The CGLX framework 200 also allows for passing user-defined messages from any head application 210 or HCI device 230 to nodes 55, 65 or 75 in the grid 1100. Users can leverage from this feature to realize independent inter-node communication and expanding support for additional HCI interfaces not currently implemented within CGLX. Messages can be passed either in a step-locked or unlocked mode. In the step-locked mode the nodes in the cluster are required to respond to a message with a signal before the program advances to the next instruction, which guarantees that the whole visualization system is in lock step. The desired message can also be passed in a non locked mode, which is of particular interest to users who wish to control additional parallel threads started within the application or independent application running on the grid.

Each message has a unique identifier which can be queried alongside with the length of the message to allow users to identify their messages and react accordingly. Users can also register special message callback routines which will be called as a reaction to an incoming custom message.

### Scalability

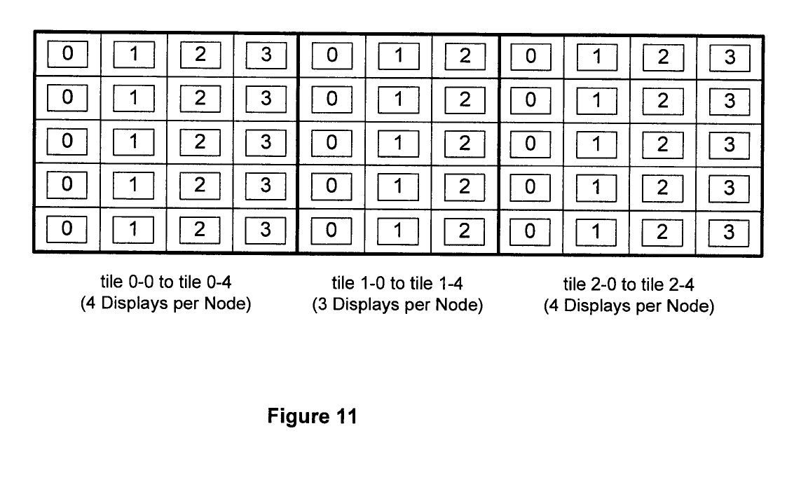

Initial performance-related tests with the CGLX framework 200 primarily focused on the scalability of the framework. Testing was conducted on the previously-described tile display system called HiPerSpace. The HiPerSpace system can deliver more that 220 million pixels with 55 high resolution displays (2560×1600 pixels per tile) and is driven by 16 (15 nodes+head node) DELL® XPS 710 workstations. Table 1 lists the hardware components of the nodes, while FIG. 11 shows the configuration of the HiPerSpace test layout.

TABLE 1

| Device | Specification |
|---|---|
| Workstation | DELL ® XPS 710 (quad-core processor), |
| | 2.40 GHz, 4 GB main memory |
| Graphics | dual NVIDIA FX5600 Quadro |
| Network | GigE Broadcom NetXtreme PCI-E |

Each node in the grid drives either three or four displays. Nodes on the left and right side of HiPerSpace (tile-0-0 to tile-0-4 and tile-2-0 to tile-2-4) are connected to four displays (two displays to one graphics card) allowing these nodes to produce a pixel output of 102640×1600 (4×2560×1600) pixel each. The center nodes (tile-1-0 to tile-1-4) are connected to three displays leaving one graphics card with only one monitor. The overall output of the system can be calculated to 225.28 megapixels.

Accurate measurement of system performance highly depends on the type of tests conducted on utilized hardware components and on the test application itself. To measure the scalability of CGLX, “RollerCoaster2000”, a well-known, freely downloadable animation program, was selected to demonstrate that any type of application can be adapted to run on CGLX. The program features high-speed visual context changes and a culling methodology that helps to illustrating the scalability of CGLX. The program loads data of a rail track in a vector array, culls all these coordinates in each rendered frame against the OpenGL viewport and generates geometry in real time to visualize a roller coaster ride. The culling algorithm used is somewhat inefficient for a cluster application because only a hierarchical culling method will allow for increased rendering performance on a cluster. However for a scalability test these conditions are nearly ideal. Removing the effect of culling (being constant) from the calculations leaves only variations of pixel resolution as the predomination factor to evaluate the scalability of the framework.

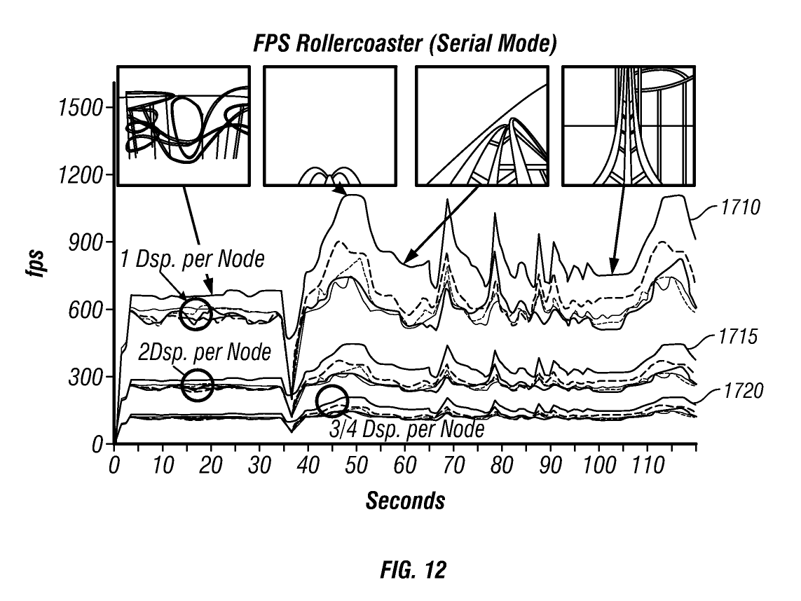

The framework was evaluated for scalability by sequentially adding nodes to the visualization grid, resulting in five different configurations with increasing number of nodes (starting with two and ending up with fifteen nodes in the grid). Each configuration was also tested with three different display configurations (meaning: one, two and three/four monitors). FIG. 12 shows the resulting diagram with CGLX configured for serial mode, which means that each display is rendered one after the other on a per node basis. As a reference the graphs in red 1710, 1715 and 1720 show a single node running the test program with the same display configurations in stand alone (solo) mode, without a visualization grid connected. As expected the performance, measured in fps (frames per second), results in three different groups of graphs showing the effect of adding displays to the rendering nodes in the grid. The difference in performance between a solo application (with the same display setup) and an application running on the grid can be explained through the overhead introduced when multiple workstations have to be synchronized over a network. This effect however, is subject to further investigation to determine the exact time delay introduced by the network.

The mean frame rates (FPS) provided in Table 2 indicate that by increasing the number of nodes in the grid in all three display setups, the performance of the systems decreases only minimally. Considering the fact that the pixel output on the grid increases nearly exponentially, this clearly indicates that the CGLX framework 200 is scalable.

TABLE 2

| | # Nodes | | | | | |
|---|---|---|---|---|---|---|
| | — | 2 | 4 | 9 | 12 | 15 |
| | Set-up | | | | | |
| | Solo | (2 × 1) | (2 × 2) | (3 × 3) | (3 × 4) | (3 × 5) |
| 1 Dsp. | 789.5 | 658.0 | 634.4 | 605.8 | 587.7 | 569.1 |
| 2 Dsp. | 317.2 | 291.9 | 281.5 | 272.7 | 262.9 | 254.3 |
| ¾ Dsp. | 146.8 | 141.6 | 143.5 | 134.2 | 134.4 | 133.9 |

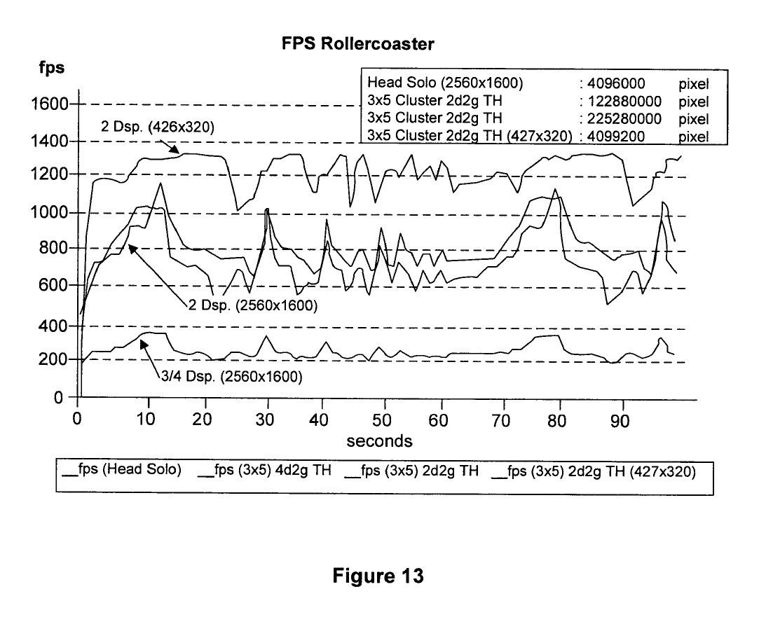

In an additional test illustrated in FIG. 13, it was demonstrated that applications running in the threaded mode exhibit a significant performance increase for all display setups. A node setup of two displays on two separate graphics cards event shows that the performance achievable matches the performance of a one display solo configuration. This leads to the conclusion that this setup is the most favorable when high performance rendering has to be combined with a maximum of pixel output.

In a setup where the visualization grid renders the same amount of pixel as a single display full screen application (2560×1600 pixels), the performance of the grid exceeds the single node performance as expected from typical visualization clusters. However, this result is influenced by the fact that the application does not feature a hierarchical culling algorithm, which is a requirement to achieve better performance results.

The inventive CGLX framework introduces a new approach to make large scale visualization systems available to a broader user spectrum. CGLX presents a familiar, easy-to-use programming interface, enabling even inexperienced programmers to utilize the capabilities of new generation massive tiled displays systems, operating at tens to hundreds of megapixel resolution, and to generate applications for a wide variation of scientific disciplines. The implemented interface approach also allows OpenGL programs developed for a single workstation to be executed on a large scale visualization grid (tiled wall system) with minimal or no changes to the original code.

The CGLX framework allows the development of programs for generation visual analytics infrastructures, which enable researchers to collaboratively view, interrogate, correlate and manipulate data in real-time with visual resolutions way beyond a single workstation.

Preliminary performance tests with CGLX show that the framework provides a scalable and performance optimized approach to displays massive visual content, on large scale visualization grids, in an interactive and flexible way. CGLX features a unique way to configure and utilize such systems enabling researches with different scientific backgrounds to utilize high performance massive tiled display system. Users can easily reconfigure their visualization grid depending on the requirements of a program and their specific needs. Together with the build in simulation World Concept, CGLX enables users to freely configure and subdivide their system to display large scale high resolution visual content or work together in a collaborative multiple users' setup with independent parallel visualization/simulation programs running in a side-by-side configuration.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

Various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art. It is further understood that the scope of the present invention fully encompasses other embodiments and that the scope of the present invention is accordingly limited by nothing other than the appended claims.

1. A distributed visualization system including a cluster graphics library for large scale, cross platform display environment (CGLX), the distributed visualization system comprising:
multiple slave nodes in a network, the multiple slave nodes including render nodes, wherein the multiple slave nodes are coupled to multiple displays;
one or more control nodes in communication with the multiple slave nodes in the network;
one or more protocol layers adapted for collaborating processes in the network including transmitting and receiving configuration and synchronization information communicated between the one or more control nodes and the multiple slave nodes, event distribution of graphics context and content according to application running on the one or more control nodes and the multiple slave nodes and managing and synchronizing multiple rendering contexts associate with the render nodes in accordance with control information associated with the distributed visualization system; and
one or more user interfaces associated with the one or more control nodes, the one or more user interface configured to receive and display parameters associated configuring and synchronizing the distributed visualization system, wherein the configuring and synchronizing of the distributed visualization system includes one or more control nodes configuring and synchronizing the multiple slave nodes.

2. The system of claim 1, wherein the one or more protocol layers adapted for transmitting and receiving configuration and synchronization information is a network layer.

3. The system of claim 1, wherein the one or more protocol layers adapted for synchronization and event distribution of graphics context and content is a cluster layer.

4. The system of claim 1, wherein the one or more protocol layers adapted for managing and synchronizing multiple rendering contexts associate with the render nodes is a render node layer.

5. The system of claim 1, wherein algorithms associated with the one or more control nodes are configured to control applications associated with the one or more slave nodes.

6. The system of claim 1, wherein the distributed visualization system is one of partitioned, merged and reshaped via the one or more user interfaces associated with the one or more control nodes.

7. The system of claim 1, wherein the distributed visualization system is configured to split a visualization grid to run multiple programs side by side.

8. The system of claim 1, wherein the multiple slave nodes are associated with at least one implementation of an open graphics library.

9. The system of claim 8, wherein the one or more control modules are configured to synchronize the open graphics library of the multiple slave nodes in accordance with a control graphics library associated with the one or more control nodes.

10. The system of claim 2, wherein the cluster layer is further adapted for frame and event synchronization.

11. The system of claim 1, wherein the network layer is further configured to propagate user defined implementations on the one or more user interfaces associated with the control node to at least a portion of the multiple slave nodes.

12. The system of claim 1, wherein the distributed tiled display system implements distribution strategies in cluster systems including one of culling and multi-threading techniques.

13. The system of claim 1, wherein synchronization of buffer swaps on the multiple slave nodes is implemented as a software solution.

14. The system of claim 1, wherein synchronization of buffer swaps on the multiple slave nodes is implemented as a hardware solution.

15. The system of claim 1, wherein the multiple slave nodes include display nodes.

16. The system of claim 1, wherein the one or more control nodes are configured to initiate communication over the network layer for starting applications across the multiple slave nodes in the network.

17. A method of creating a distributed visualization system utilizing heterogeneous systems connected through a network, the method comprising:
networking a set of nodes coupled to multiple displays, wherein the set of nodes include one or more master nodes and multiple slave nodes;
transmitting and receiving configuration and synchronization information communicated between the one or more master nodes and the multiple slave nodes over one or more protocol layers of the scalable tiled display system;
distributing one or more events of graphics context and content according to one or more applications running on the one or more master nodes and the multiple slave nodes;
managing and synchronizing multiple rendering contexts associate with the slave nodes in accordance with control information associated with the distributed visualization system;
configuring the distributed visualization system, including configuring the multiple slave nodes with the one or more master nodes; and
synchronizing the distributed visualization system, including synchronizing the multiple slave nodes with the one or more master nodes.

18. The method of claim 17, further comprising generating a user interface associated with the one or more master nodes.

19. The method of claim 18, wherein the configuration of the multiple slave nodes is according to user defined parameters implemented on a user interface associated with the one or more master nodes.

20. The method of claim 17, wherein each node of the set of nodes possesses information of the node's capability and is configured to one of communicate the information over the one or more protocol layers or be remotely accessed and queried for at least a portion of the information.

21. The method of claim 20, wherein applications associated with the set of nodes are started according to the information communicated over the one or more protocol.

22. The method of claim 17, wherein the one or more master nodes are configured to query the network and acquire an inventory of computer related resources, including computer related resources available to the slave nodes, and composite the computer related resources into multi-tile display contexts.

23. The method of claim 22, wherein the multi-tile display contexts exist in co-located format.

24. The method of claim 22, wherein synchronizing the distributed visualization system further comprises:
connecting to the multiple slave nodes via a background application;
configuring the multiple slave nodes according to a set of parameters; and
selecting a start application.

25. The method of claim 22, wherein the one or more selected master nodes query the network and obtain an inventory of resources and composite the resources into extended, multi-tile display contexts.

26. The method of claim 25, wherein the multi-tile display contexts exist in a co-located format.

27. The method of claim 17, further comprising splitting a visualization grid to run multiple programs side by side on the distributed visualization system.

28. A method of creating a distributed visualization system utilizing heterogeneous systems connected through a network, the method comprising:
a means for networking a set of nodes coupled to multiple displays, wherein the set of nodes include one or more master nodes and multiple slave nodes;
a means for transmitting and receiving configuration and synchronization information communicated between the one or more master nodes and the multiple slave nodes over one or more protocol layers of the scalable tiled display system;
a means for distributing one or more events of graphics context and content according to one or more applications running on the one or more master nodes and the multiple slave nodes;
a means for managing and synchronizing multiple rendering contexts associate with the slave nodes in accordance with control information associated with the distributed visualization system; and
a means for configuring the distributed visualization system, including configuring the multiple slave nodes with the one or more master nodes.
